(19) United States
(12) Patent Application Publication
(10) Pub. No.: US 2015/0318736 A1
(43) Pub. Date: Nov. 5, 2015

(54) SELF-CONTAINED RECHARGEABLE ELECTRICAL-POWER CELL

(71) Applicant: Benjamin T. Franco, Lunenburg, MA (US)

(72) Inventor: Benjamin T. Franco, Lunenburg, MA (US)

(21) Appl. No.: 14/703,641

(22) Filed: May 4, 2015

Related U.S. Application Data
(60) Provisional application No. 61/988,207, filed on May 3, 2014.

(51) Int. Cl. H02J 7/35

(52) U.S. Cl. CPC H02J 7/355

(57) ABSTRACT

A self-contained rechargeable electrical-power cell includes a canister with an exterior configuration generally approximating the configuration of a standard battery. An interior cell cavity defined by the canister contains a rechargeable voltaic cell. A photovoltaic panel is disposed along an outer surface of the canister and electrically linked to the rechargeable voltaic cell through electrical charging circuity such that, in a charging mode, electrical current outputted by the photovoltaic panel is communicated to the rechargeable voltaic cell, where it is stored as electric charge. Electrical-power cell positive and negative terminals are defined on an exterior surface of the canister and electrically communicate (i.e., are electrically linked) with the rechargeable voltaic cell such that electric charge stored within the rechargeable voltaic cell can be selectively discharged through the terminals in order to energize an external electrical circuit within which the electrical-power cell is incorporated in place of a standard battery,

### PROVISIONAL PRIORITY CLAIM

Priority based on Provisional Application Ser. No. 61/988,207 filed Saturday, May 3, 2014, and entitled “SELF-CONTAINED RECHARGEABLE ELECTRICAL POWER CELL” is claimed. Moreover, the entirety of the previous provisional application, including the drawings, is incorporated herein by reference as if set forth fully in the present application.

### BACKGROUND

Rechargeable batteries or “electrical-power cells” have been in existence for decades. A traditional battery charger for small appliance and toy batteries, for example, includes a plurality of battery-receiving seats into which batteries to be recharged are inserted. When batteries to be recharged are properly seated within a battery charger, the electrical poles (or terminals) of the battery are situated in electrical contact with counterpart poles (terminals) of the battery charger so that the batteries can be re-energized by a flow of electric current delivered by the battery charger.

While traditional battery chargers are themselves energized by an AC power source via, for example, an electrical wall socket, further developments in the related technology eventually resulted in battery chargers energized by electro-magnetic radiation (i.e., light) through photo-voltaic panels or cells, which are commonly referred to as “solar panels” or “solar cells.” While solar-powered battery chargers obviate the need to connect the charger to a power source through an electrical cord, and can therefore be transported, they are still nonetheless relatively bulky units are inconvenient to transport.

Accordingly, a need exists for a self-contained rechargeable electrical-power cell that requires no external device from which to receive electrical charge.

### SUMMARY

In each of various alternative embodiments, a self-contained rechargeable electrical-power cell (alternatively referred to as “battery”) includes a canister having an external configuration that sufficiently approximates the size and shape of a standard battery that it can be substituted for that standard battery in a device typically energized by the same. By way of non-limiting example, it is envisioned that specific embodiments within the scope of the invention as defined in the claims appended hereto can replace battery types referred to as “AA,” “AAA,” “C,” “D,” and “9V.” While most of these batteries are of generally cylindrical configuration, specific embodiments may deviate from the standard cylindrical shape so long as there configurations are sufficiently compatible with the standard cylindrical shape to serve as suitable replacements for the same from a dimensional standpoint. For example, a specific version may include a side that is more than half cylindrical but also includes a planar portion containing, for example, a solar cell, a feature that will be more completely appreciated further in this specification.

The canister of an illustrative self-contained rechargeable battery is defined by at least one side wall with side-wall inner and outer surfaces. The at least one side wall extends longitudinally between closed canister upper and lower ends. The at least one side wall and the upper and lower ends define an enclosed cell cavity within which there is situated a rechargeable voltaic cell including a cell cathode and cell anode.

Disposed along the outer surface of the canister side wall is a photovoltaic panel which may be comprised, for example, by one or more solar cells. The photovoltaic panel includes first and second panel leads and is configured for converting electromagnetic energy that impinges thereon into electrical current. Electrical charging circuitry is situated in electrical communication with the photovoltaic panel through the first and second panel leads and the rechargeable voltaic cell through the cell cathode and cell anode. The electrical charging circuitry is configured such that, in a charging mode, electric current outputted by the photovoltaic panel is communicated to the rechargeable voltaic cell, where it is stored as electric charge. In an exemplary embodiment, the charging circuitry is disposed within the cell cavity. The term “circuitry” is used throughout the specification in a sense sufficiently broad to incorporate circuit components individually, including, not limited to, resistors, capacitors, wires, electrically-conductive, and bonding agents, and is not limited to the charging circuitry. Moreover, because the details electrical circuitry sufficient to achieve the stated objective can designed by a person of ordinary skill in the relevant art without undue experimentation, portions of the circuitry, and representative circuit components, are depicted only schematically.

The canister further includes electrical-power cell positive and negative terminals. Each of these electrical terminals is defined in one of the upper and lower canister ends, but there are variations among alternative embodiments. For instance, where the canister of the electrical-power is configured to enable the electrical-power cell to substitute for a standard cylindrical battery type such as, by way of non-limiting example, a AA, AAA, C or D battery, the electrical-power cell positive and negative terminals are defined in opposite canister ends. In more specific versions, the upper canister end is defined so as to include the positive terminal and the lower canister end is configured so as to include the negative terminal. In a version intended to substitute for a standard 9V battery having the general configuration of a rectangular solid, both the electrical-power cell positive and negative terminals are defined in the same canister end which, by convention, is generally regarded as the top or upper end.

Electrical discharging circuitry is situated in electrical communication with the rechargeable voltaic cell through the cell cathode and cell anode and the positive and negative terminals of the electrical-power cell. The discharging circuitry is configured such that, when the electrical-power cell is incorporated within an external electrical circuit (not shown) for the purpose of energizing that external electrical circuit, electric charge stored within the rechargeable voltaic cell can be selectively discharged into the external circuit through the electrical discharging circuitry. As with the charging circuitry, the details of circuitry necessary facilitate selective discharge of electrical current from the voltaic cell into the external circuit are well within the intellectual compass of one of ordinary skill to which the invention pertains and, therefore, outside the points of novelty requiring detailed rendering within the drawing(s).

Representative embodiments are more completely described and depicted in the following detailed description and the accompanying drawings.

### BRIEF DESCRIPTION OF THE DRAWINGS

FIG. 1 is a schematic representation of a self-contained rechargeable electrical-power cell.

### DETAILED DESCRIPTION

The following description of variously configured self-contained rechargeable electrical-power cells is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

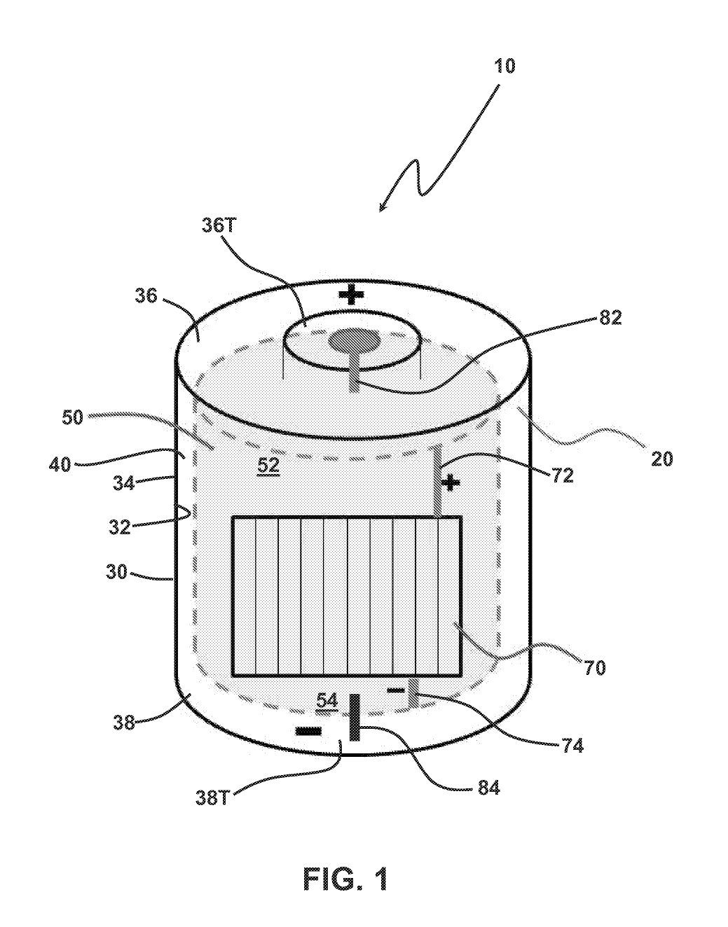

Referring to FIG. 1, an illustrative self-contained rechargeable electrical-power cell 10 (hereinafter “electrical-power cell 10”) includes a canister 20 having at least one side wall 30 with side-wall inner and outer surfaces 32 and 34. The at least one side wall 30 extends longitudinally between closed canister upper and lower ends 36 and 38, and defines an interior cell cavity 40.

Situated within the cell cavity 40 is a rechargeable voltaic cell 50 including positive and negative electrodes 52 and 54 (i.e., respectively, “cell cathode 52” and “cell anode 54”). Disposed along or within the outer surface 34 of the canister side wall 30 is a photovoltaic panel 70 configured for converting electromagnetic energy (e.g., sunlight) that impinges thereon into electrical current. In a charging mode, electrical current outputted by the photovoltaic panel 70 is communicated through electrically-conductive first and second panel leads 72 and 74 to the rechargeable voltaic cell 50, where it is stored as electric charge. The first and second panel leads 72 and 74 and the cell cathode 52 and cell anode 54 may be regarded as circuit components included among more generally referenced “electrical charging circuitry” configured for communicating the electrical output of the photovoltaic panel 70 to the rechargeable voltaic cell 50 for storage. However, as discussed briefly in the summary, the electrical charging circuitry may include additional circuit components that are not depicted such as, by way of is example, resistors and capacitors.

With adequate charge stored in the rechargeable voltaic cell 50, the canister 20 can be incorporated into an external electrical circuit (not shown) in place of either (i) a non-rechargeable battery or (ii) a battery that is rechargeable by conventional means (i.e., within a battery charger). To this end, the canister 20 is defined by exterior dimensions that generally conform to or approximate the exterior dimensions of a standard battery that the electrical-power cell 10 is configured to replace. Among alternative versions, there might be minor deviations from strict conformity with a standard battery shape. For instance, in some alternative embodiments, the photovoltaic panel 70 is curved to conform to the cylindrical side wall 30 wall in those cases in which the side wall 30 is cylindrical, but the photovoltaic panel 70 could also be generally planar even where the side wall 30 is otherwise cylindrical.

In order that the electrical-power cell 10 can energize an electrical circuit in which it is incorporated, the canister upper and lower ends 36 and 38 are configured to function as, respectively, upper and lower terminals 36T and 38T of mutually opposite electrical polarity. The terminal configuration most commonly associated with cylindrical batteries such as “AA,” “AAA,” “C” and “D” batteries, for example, is for the end typically regarded as the top end to include (defined) a projection or protrusion constituting the positive terminal, while the lower or base end opposite the top end is relatively flat and constitutes the negative terminal. Accordingly, in the illustrative embodiment of FIG. 1, the terminal 36T defined by the canister upper end 36 is depicted as the positive terminal, while the terminal 38T defined by the canister lower end 38 is depicted as the negative terminal.

When the canister 20 is electrically connected to a load incorporated with the canister 20 in a dosed external electrical circuit, the rechargeable voltaic cell 50 is in, or can be selectively put into, a “discharged mode” in which it provides electrical current to the external electrical circuit. Electrical discharge of the rechargeable voltaic cell 50 is through the canister 20 is facilitated by “discharging circuitry” which can include, for example, electrically-conductive cell leads 82 and 84 connecting, respectively, the cell cathode 52 to the upper (positive) terminal 36T and the cell anode 54 to the lower (negative) terminal 381 defined on the canister 20.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A self-contained rechargeable electrical-power cell comprising:
a canister having at least one side wall with side-wall inner and outer surfaces longitudinally extending between longitudinally opposed upper and lower canister ends, the side wall and upper and lower ends defining an interior cell cavity;
a rechargeable voltaic cell situated within the cell cavity and including a cell cathode and cell anode;
a photovoltaic panel disposed along the outer surface of the canister side wall and including electrically-conductive first and second panel leads, the photovoltaic panel being configured for converting electromagnetic energy that impinges thereon into electrical current;
electrical charging circuity situated in electrical communication with the photovoltaic panel through the first and second panel leads and the rechargeable voltaic cell through the cell cathode and cell anode, and configured such that, in a charging mode, electric current outputted by the photovoltaic panel is communicated to the rechargeable voltaic cell, where it is stored as electric charge;
electrical-power cell positive and a negative terminals, each of which terminals is defined in one of the upper and lower canister ends; and
electrical discharging circuitry situated in electrical communication with the rechargeable voltaic cell through the cell cathode and cell anode and the positive and negative terminals, and configured such that, when the electrical-power cell is incorporated within an external electrical circuit for the purpose of energizing that external electrical circuit, electric charge stored within the rechargeable voltaic cell can be selectively discharged into the external circuit through the electrical discharging circuitry.

2. The electrical-power cell of claim 1 wherein the electrical-power cell positive and negative terminals are defined in opposite canister ends.

3. The electrical-power cell of claim 2 wherein the electrical-power cell positive terminal is defined in the upper canister end and the electrical-power cell negative terminal is defined in the lower canister end.

4. The electrical-power cell of claim 3 configured to substitute for a standard cylindrical battery type.

5. The electrical-power cell of claim 4 wherein the standard battery type is one of (i) AA, (ii) AAA, (iii) C, and (iv) D.

6. The electrical-power cell of claim 1 wherein both the electrical-power cell positive and negative terminals are defined in the same canister end.

7. The electrical-power cell of claim 6 configured to substitute for a standard 9V battery.

8. A self-contained rechargeable electrical-power cell comprising:
a canister having an outer surface and an inner surface defining an interior cell cavity;
a rechargeable voltaic cell situated within the cell cavity;
a photovoltaic panel disposed along the outer surface of the canister;
electrical charging circuitry electrically linking the photovoltaic panel to the rechargeable voltaic cell such that, in a charging mode, electrical current outputted by the photovoltaic panel is communicated to the rechargeable voltaic cell and stored as electric charge;
electrical-power cell positive and negative terminals defined on an exterior surface of the canister: and
electrical discharging circuitry electrically linking the rechargeable voltaic cell to the electrical-power cell positive and negative terminals such that electric charge stored within the rechargeable voltaic cell can be selectively discharged through the positive and negative terminals.
